(19) United States
(12) Patent Application Publication
(10) Pub. No.: US 2025/0109804 A1
(43) Pub. Date: Apr. 3, 2025

(54) Secure container for a chain used for actuating a chain valve

(71) Applicants: Jacques Bergeron, Sherbrooke (CA); Richard Morin, Val-Joli (CA)

(72) Inventors: Jacques Bergeron, Sherbrooke (CA); Richard Morin, Val-Joli (CA)

(21) Appl. No.: 18/904,844

(22) Filed: Oct. 2, 2024

(30) Foreign Application Priority Data
Oct. 2, 2023 (GB) 2315086.5

(51) Int. Cl. F16K 31/46

(52) U.S. Cl. CPC F16K 31/465

(57) ABSTRACT

The present invention relates to a system and method for safely storing and managing a chain loop used in actuating industrial valves. The system includes a secure container configured to retain and organize the chain loop when not in active use. This container includes a unique triangular prism shape that efficiently utilizes space near the valve and includes an opening surrounded by a peripheral funneling lip to guide the chain loop smoothly back into the container. An interior chain retaining track within the container ensures that the chain is neatly coiled and prevents tangling. Additionally, the container is equipped with locking holes for securing the chain with a lock and a hooking bracket that allows for easy attachment and detachment from a nearby hook. This invention simplifies the operation of chain actuated valves and significantly enhances safety by preventing the chain from becoming a hazard in traffic areas. The system's method of use involves deploying and retracting the chain via a pole with a holding mechanism, making it accessible and efficient in industrial settings.

### CROSS-REFERENCE TO RELATED APPLICATIONS

The present application claims priority to UK application number GB2315086.5, filed on Oct. 2, 2024, the disclosure of which is hereby incorporated in its entirety at least by reference.

### BACKGROUND OF THE INVENTION

### 1. Field of the Invention

The present invention relates generally to chain actuated valves but more particularly to a secure container for a chain used for actuating a chain valve.

### 2. Description of Related Art

Chain actuated valves such as process control valves, for example, are most useful in situations that require precise control over fluids, steam, and gases. Valves allow for the management of flow rates of fluids, liquids, or gases, as well as for the management of temperature, pressure, and level. There are many industries that use control valves that are fitted with chains. These chains allow the valves to be opened or closed without requiring stepladders or ladders to reach the maneuvering wheel of the control valve. These chain valve systems have been around for many years, but given the number of accidents linked to poorly stored chains, there is a need for properly and securing those chains.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a main object of the present disclosure to provide for a secure container for a chain used for actuating a chain valve.

In order to do so, the present invention provides for a secure container for use with chain valves that are operated by a chain loop mechanism. It comprises:
a) a container configured to retain the chain loop, the container having an opening and a peripheral funneling lip around the opening; and
b) a holding mechanism configured to removably secure the container.

The container further comprises locking holes configured to receive a lock, a hooking bracket configured to releasably engage a hook.

The container has a generally triangular prism shape.

The chain retaining track is curved.

The hook engaged by the hooking bracket is located on the chain guide.

The system is further comprised of a pole having a holding mechanism at its distal end, the holding mechanism configured to engage with the container for maneuvering the container between a stored position and an operational position.

The holding mechanism on the pole is configured to disengage the hooking bracket from the hook.

The system has a method for controlling an industrial valve actuated by a chain loop, the method comprising:
a) providing a container with an opening and a peripheral funneling lip around the opening;
b) using a pole with a holding mechanism to remove the container from a hook, allowing the chain loop to extend from the container;
c) actuating the valve by pulling on the chain loop; and
d) using the pole to maneuver the container back to the hook, with the funneling lip guiding the chain loop back into the container.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1A Isometric view showing a valve wheel with the invention in its lowered configuration, with a user engaging the hook with a pole in order to raise the container, according to an embodiment of the invention.

FIG. 1B Isometric view showing a valve wheel with the invention in its raised configuration, according to an embodiment of the invention.

FIG. 2 Isometric view showing the container assembly with the holding mechanism hooked on the valve bracket assembly, according to an embodiment of the invention.

FIG. 3 Isometric view showing the container assembly in its high configuration, hooked on the valve bracket assembly (Stored position), also showing a locking method option according to an embodiment of the invention.

FIG. 4 Isometric exploded view of the invention

FIG. 5 Isometric view of the invention according to an embodiment of the invention.

FIG. 6 Isometric view with hidden lines of the invention according to an embodiment of the invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to provide a secure container for a chain used for actuating a chain valve.

It is to be understood that the terminology used herein is for the purpose of describing particular embodiments only and is not intended to be limiting. The terms “a” or “an,” as used herein, are defined as to mean “at least one”. The term “plurality,” as used herein, is defined as two or more. The term “another,” as used herein, is defined as at least a second or more. The terms “including” and/or “having,” as used herein, are defined as comprising (i.e., open language). The term “coupled,” as used herein, is defined as connected, although not necessarily directly, not necessarily mechanically, and not permanent. The term “providing” is defined herein in its broadest sense, e.g., bringing/coming into physical existence, making available, and/or supplying to someone or something, in whole or in multiple parts at once or over a period of time. As used herein, the terms “about”, “generally”, or “approximately” apply to all numeric values, whether or not explicitly indicated. These terms generally refer to a range of numbers that one of skill in the art would consider near the stated amount by about 0%, 5%, or 10%, including increments therein. In many instances these terms may include numbers that are rounded to the nearest significant figure.

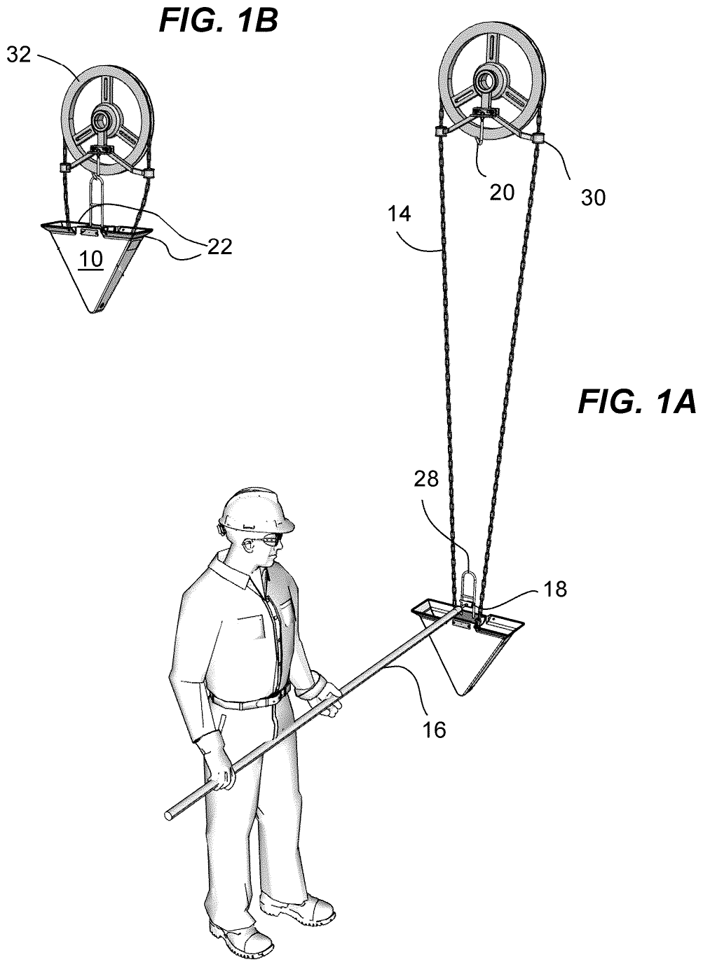

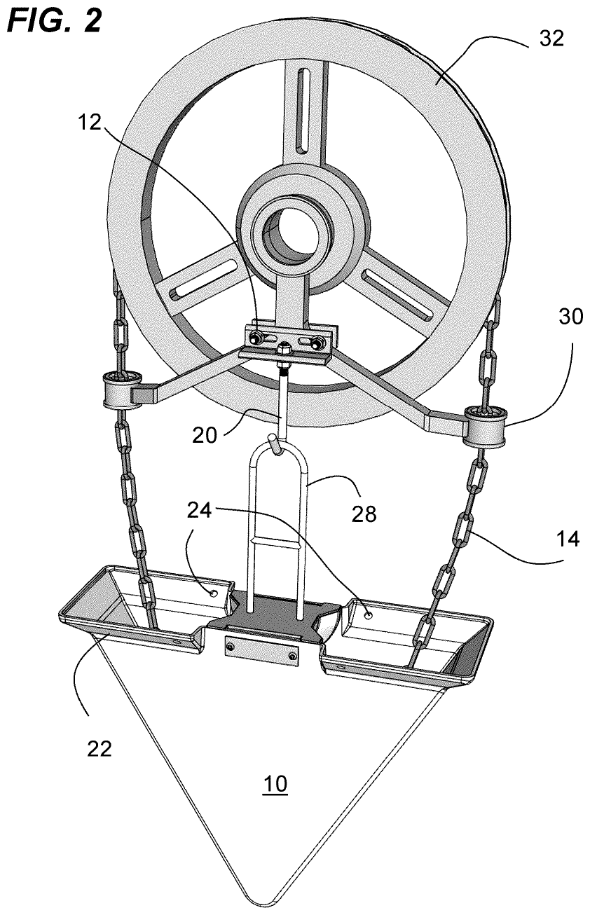

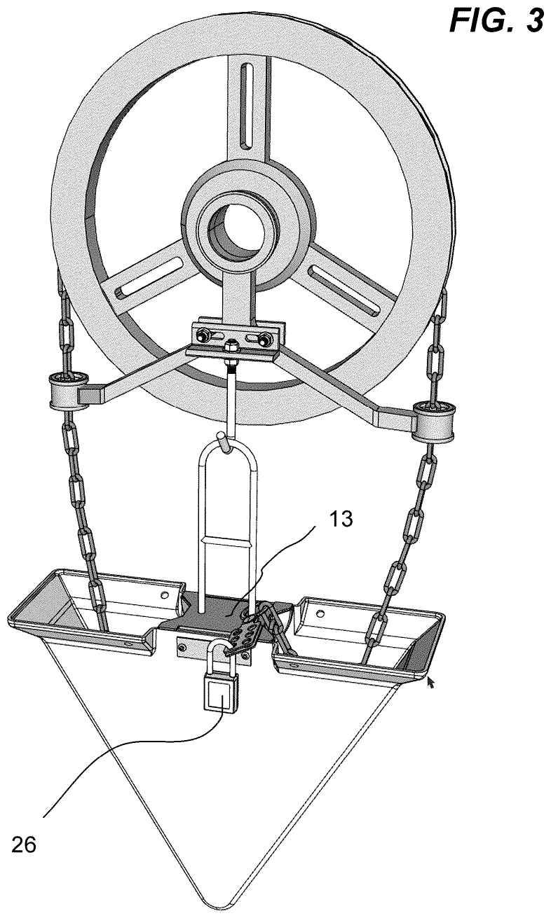

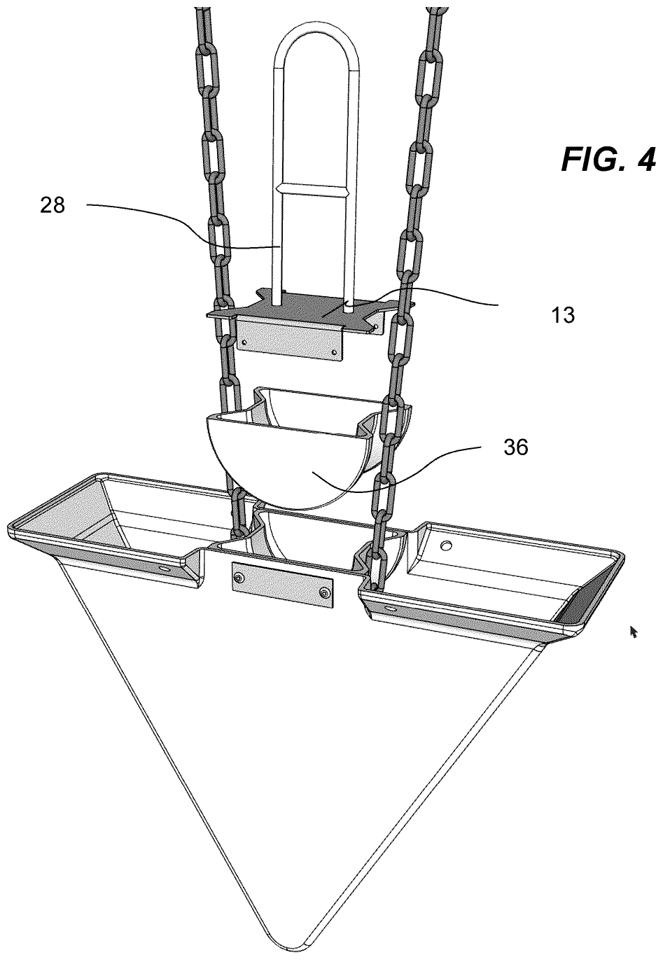

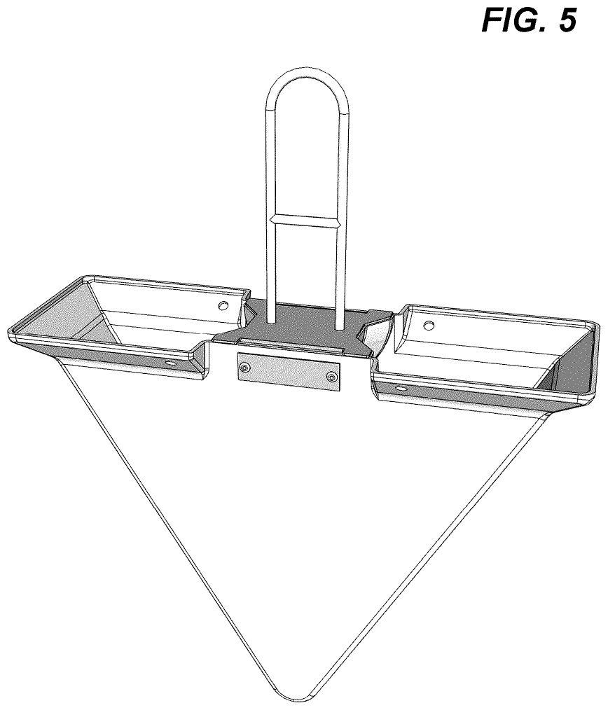

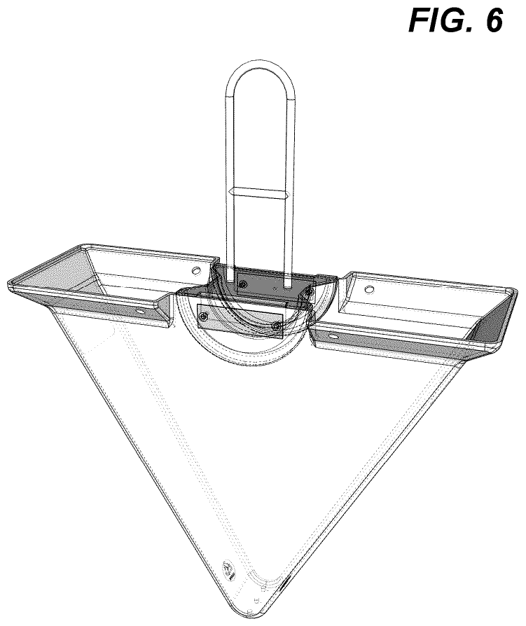

Referring now to any of the accompanying FIGS. 1-4, ta secure container 10 configured for controlling industrial valves that are actuated by a chain loop 14 is illustrated.

In one embodiment, the secure container is accompanied by a pole 16 having a holding mechanism 18 at its distal end for engaging the secure container 10. The holding mechanism 18 at the distal end of the pole 16 may include a hook, clasp, gripping jaws, or other engagement means designed to interact with the hooking bracket 28 of the container 10. This mechanism allows the user to securely engage and manipulate the container 10 from a distance, facilitating the removal and replacement of the container 10 onto the hook 20 without the need for ladders or direct contact.

In one embodiment, the container 10 is provided for retaining the chain loop 14 when not in use. In one embodiment, the container 10 has four walls forming a generally triangular prism shape. In another embodiment, the container 10 includes a peripheral funneling lip 22 around its upper opening to guide the chain loop 14 back into the container 10.

In some embodiments, the container 10 further includes locking holes 24 for receiving a padlock (not shown) to lock the chain loop 14 in place when the valve is open or closed. In some embodiments, additionally the container 10 also includes a curved chain retaining track 36 on its interior for orderly retaining the wrapped chain loop 14. Lastly, in some embodiments, the container 10 includes a hooking bracket 28, such as a protruding tab, which may be adjustable or include features like slots or holes to accommodate hooks of various sizes and shapes. The hooking bracket 28 is designed to releasably engage with a hook 20, facilitating easy attachment and detachment of the container 10.

In use, the holding mechanism 18 of the pole 16 is used to remove the container 10 from the hook 20 by engaging and lifting the hooking bracket 28 upward, thereby disengaging it from the hook 20. The pole 16 then maneuvers the container 10 downward, allowing the wrapped chain loop 14 to fully extend from the container 10 as it is lowered. The chain loop 14 is caught and organized along the curved chain retaining track 36 inside the container, preventing tangling,. At this point, the chainwheel 32 and associated valve can be actuated by pulling on either side of the chain loop 14, which remains engaged with the chainwheel 32.

Once the valve operation is complete, the operator uses the pole 16 to maneuver the container 10 back upward into position towards the chain guide 30. The chain loop 14 re-wraps into the container 10 due to the guiding effect of the funneling lip 22. More specifically, the peripheral funneling lip 22 aids in guiding the chain loop 14 smoothly back into the container 10 as it is raised. The hooking mechanism 28 is then re-engaged with the hook 20 of the chain guide 30 or other hook nearby (not shown) to securely mounting the container 10 during non-use. This process safely stores the chain loop 14, preventing it from becoming a hazard in the workspace. The hook 20 is fixedly attached to a hook bracket 12 which is mechanically fastened to the chain guide 30 or another hook if the chain guide 30 is obstructed. This arrangement ensures that the container 10 can be securely mounted in proximity to the valve regardless of the installation environment. A cover plate 13 covers the chain retaining track 36 and is where the hooking mechanism 28 is fixedly attached to. The chain loop 14 can also be locked into position using the padlock and locking holes 24 for added security.

The secure container 10 provides safe storage of the chain loop 14, using only the pole 16, avoiding risks associated with leaving loose chains in traffic areas. The secure container 10 keeps the chain loop 14 organized and secure both during use and non-use of the valve.

In alternative embodiments, the container 10 may be constructed from various materials such as metals, plastics, or composites to suit different environmental conditions, including high temperatures, corrosive atmospheres, or outdoor installations. The pole 16 may be telescopic or modular to accommodate different heights and reach requirements. Additionally, the holding mechanism 18 could utilize magnetic elements, suction devices, or other fastening means to engage the container 10, providing flexibility in different operational contexts.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention. For example, while the embodiments described herein primarily focus on industrial valve operations, it is to be understood that the secure container and its associated mechanisms can be adapted for various other applications where chain management is critical. For instance, the secure container could be employed in marine, construction, or mining environments where control over chains is essential to operate heavy machinery or to secure equipment against environmental forces. Furthermore, the container's design and materials may be varied to suit different environmental conditions such as extreme temperatures, corrosive atmospheres, or underwater applications. This flexibility in design extends the utility of the secure container beyond traditional settings, offering a versatile solution for chain management in any industry requiring reliable and safe operation of chained mechanisms.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

1. A system for controlling an industrial valve actuated by a chain loop, the system comprising:
a. a container configured to retain the chain loop, the container having an opening and a peripheral funneling lip around the opening; and
b. a holding mechanism configured to removably secure the container.

2. The system of claim 1, wherein the container further comprises locking holes configured to receive a lock.

3. The system of claim 1, wherein the container further comprises a hooking bracket configured to releasably engage a hook.

4. The system of claim 1, wherein the container has a generally triangular prism shape.

5. The system of claim 1, wherein the chain retaining track is curved.

6. The system of claim 3, wherein the hook engaged by the hooking bracket is located on the chain guide.

7. A container for retaining a chain loop used to actuate an industrial valve, the container comprising:
a. an opening;
b. a peripheral funneling lip around the opening;
c. an interior chain retaining track; and
d. a hooking bracket.

8. The container of claim 7, further comprising locking holes configured to receive a lock.

9. The container of claim 7, wherein the container has a generally triangular prism shape.

10. The container of claim 7, further comprising a cover plate covering the chain retaining track, the hooking mechanism fixedly attached to the cover plate.

11. The system of claim 1, further comprising a pole having a holding mechanism at its distal end, the holding mechanism configured to engage with the container for maneuvering the container between a stored position and an operational position.

12. The system of claim 11, wherein the holding mechanism on the pole is configured to disengage the hooking bracket from the hook.

13. A method for controlling an industrial valve actuated by a chain loop, the method comprising:
a. providing a container with an opening and a peripheral funneling lip around the opening;
b. using a pole with a holding mechanism to remove the container from a hook, allowing the chain loop to extend from the container;
c. actuating the valve by pulling on the chain loop; and
d. using the pole to maneuver the container back to the hook, with the funneling lip guiding the chain loop back into the container.
